(19) United States
(12) Patent Application Publication
(10) Pub. No.: US 2014/0378235 A1
(43) Pub. Date: Dec. 25, 2014

(54) Articulated Halfshaft for an Amphibian

(71) Applicant: Gibbs Technologies Limited, Warwickshire (GB)

(72) Inventor: Neil Graham Jenkins, Warwickshire (GB)

(21) Appl. No.: 14/376,771

(22) PCT Filed: Feb. 5, 2013
(86) PCT No.: PCT/GB2013/050259

§ 371 Date: Aug. 5, 2014

Related U.S. Application Data
(63) Continuation-in-part of application No. 13/367,948, filed on Feb. 7, 2012.

(51) Int. Cl. F16D 3/32; B60K 17/22; B60F 3/00

(52) U.S. Cl. CPC F16D 3/32; B60F 3/00; B60K 17/22
USPC 464/106

(57) ABSTRACT

An articulated shaft for an amphibian driveline includes at least two shaft portions and at least three points of articulation, wherein the articulated shaft is movable between a protracted position for use of the amphibian on land and a retracted position for use of the amphibian on water. An amphibian comprising the articulated shaft, and a powertrain comprising the articulated shaft is also provided.

### BACKGROUND OF THE INVENTION

The present invention relates to an articulated halfshaft particularly suitable for use in an amphibian capable of travel on land and water. More particularly, the articulated halfshaft is suitable for use with at least one retractable wheel or track drive in a high speed amphibian capable of planing on water. The present invention also relates to an amphibian incorporating such an articulated halfshaft.

It is known, for example from U.S. Pat. No. 5,531,179 of the present applicant, for amphibians to have wheel and suspension assemblies which are retractable, so that the wheels are raised above the water line when the amphibian is operated on water. This reduces hydrodynamic resistance (drag), and allows for increased speed. The amphibian can then operate in a planing mode on water, and not just in a displacement mode only. However, known halfshafts, and in particular those used in automotive applications, have limited ability in terms of the angles of articulation possible. Furthermore, there are servicing and reliability issues when transmitting power and/or rotation at speed at increased angles of articulation.

Prior art automotive halfshafts generally comprises two constant velocity (hereinafter “CV”) joints arranged in a spaced apart manner, joined by stub and/or intermediate shafts. The resulting driveshaft is commonly known as a halfshaft, axleshaft, CV shaft or CV axle. Whilst the halfshaft may transmit power and provide drive to a supported wheel in the manner of a driveshaft, it may also be used simply to support a wheel and not provide any power transmission or drive.

The use of CV joints permits limited articulation at two points in the halfshaft such that vertical movement of a wheel is possible, usually supported via a suspension assembly. Splined connection of the stub and/or intermediate shafts or plunging CV joints may be used to accommodate geometry changes on movement of the wheel. Such an arrangement provides for bump and rebound, so as to improve the ride and handling characteristics of a vehicle. It also provides for a substantially constant rotating speed of a shaft over a range of angles between input and output.

However, the degree of articulation achievable is limited due to the geometrical constraints of known articulating joints (CV joints, Rzeppa joints, tripod joints, Hooke's joints, Thompson CV joints and universal joints) since mechanical resistance to rotation and even geometric lock can occur beyond operational angles. Ultimately, this gives rise to servicing issues and failure of the articulating joint when it is operated at the larger angles of the limited articulation available. Such limitations do not present a problem in automotive applications where the amount of vertical travel of a wheel to be accommodated is limited. Furthermore, in amphibians where the dead rise angle of the hull is low (e.g. 0 to 5 degrees), it is still possible to retract the wheels sufficiently (wheel axle angles generally of between 15 and 45 degrees above the horizontal) to enable planing when the amphibian is operated on the water.

However, there remains a need to retract wheel and track drives yet further, to achieve wheel or track axle angles of 90 degrees or more above the horizontal. This is of particular benefit in amphibians where the dead rise angle of the hull is more severe (e.g. 10 degrees or more), and/or where there is a need for improved ground clearance which in turn requires a greater height of upright in the suspension assembly.

This presents significant problems in terms of the degree of articulation required (not to mention also the additional articulation about a vertical axis required for steering), packaging, weight distribution and also in terms of how the resulting power transmission pathways can be realised.

The present invention seeks to address the aforementioned problems.

### SUMMARY OF THE INVENTION

Accordingly, the present invention provides, in a first aspect an articulated shaft for an amphibian driveline, the articulated shaft comprising:

at least two shaft portions; and

at least three points of articulation, wherein:

the articulated shaft is movable between a protracted position for use of the amphibian on land and a retracted position for use of the amphibian on water.

In a second aspect, the present invention provides an amphibian comprising the articulated shaft.

In a third aspect, the present invention provides a powertrain comprising the articulated shaft.

These and other features, advantages, and objects of the present invention will be further understood and appreciated by those skilled in the art by reference to the following specification, claims, and appended drawings.

### BRIEF DESCRIPTION OF THE DRAWINGS

Preferred embodiments of the present invention will now be described by way of example only with reference to the accompanying drawings, in which:

FIG. 1 is a schematic rear elevation view of a conventional road car transmission to a driven wheel, with the wheel shown at a normal ride height;

FIG. 2 is a schematic rear elevation view of the conventional road car transmission of FIG. 1 with the wheel shown at a full bump position;

FIG. 3 is a schematic plan view from above of the conventional road car transmission of FIGS. 1 and 2 with the wheel shown in two extremes of steering position;

FIG. 4 is a schematic sectional view of a conventional plunging type CV joint;

FIG. 5 is a schematic elevation view of a first preferred embodiment of halfshaft according to the present invention;

FIG. 6 is a schematic elevation view of a further preferred embodiment of halfshaft according to the present invention;

FIG. 7 is a schematic rear elevation view of amphibian transmission to a front steered wheel (optionally driven) incorporating the first preferred embodiment of halfshaft of FIG. 5 according to the present invention, with the wheel shown at a normal ride height;

FIG. 8 is a schematic rear elevation view of the amphibian transmission of

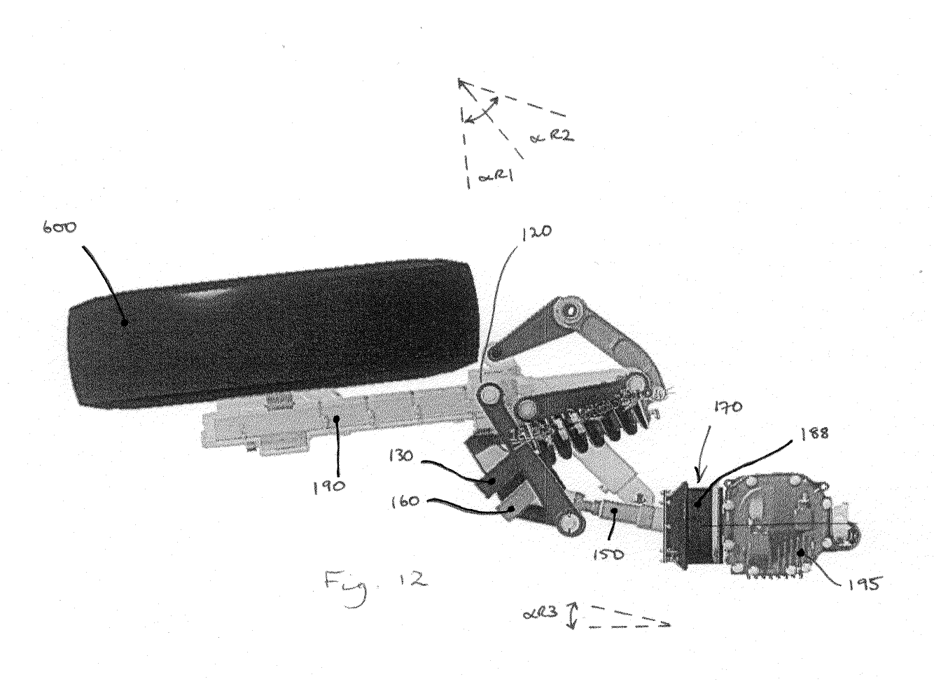

FIG. 7, with the wheel shown semi-retracted;

FIG. 9 is a schematic rear elevation view of the amphibian transmission of

FIG. 7, with the wheel shown fully retracted;

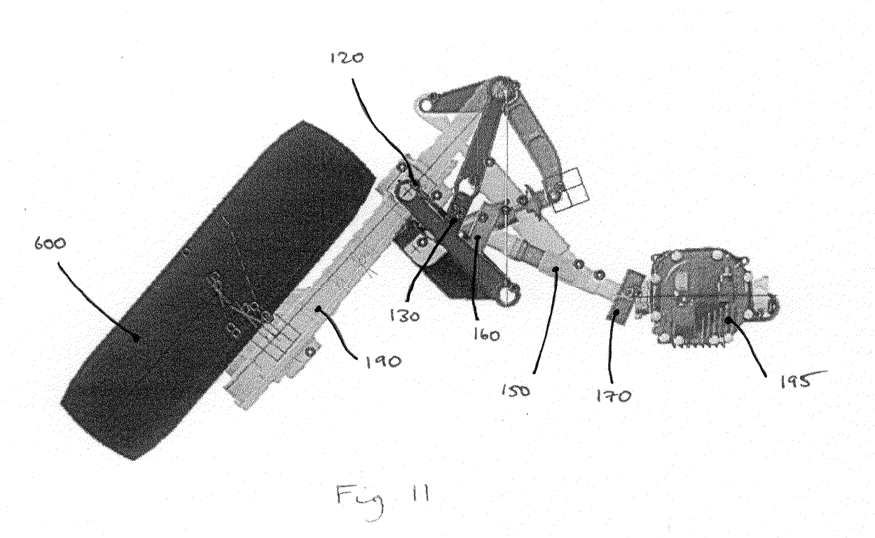

FIG. 10 is a schematic rear elevation view of amphibian transmission to a rear non-steered wheel (optionally driven) incorporating the further preferred embodiment of halfshaft of FIG. 6 according to the present invention, with the wheel at shown at a normal ride height;

FIG. 11 is a schematic front elevation view of the amphibian transmission of FIG. 10, with the wheel shown semi-retracted;

FIG. 12 is a schematic front elevation view of the amphibian transmission of

FIG. 11, with the wheel shown fully retracted; and

FIG. 13 is a detail schematic view in section of a centering mechanism for use in a halfshaft according to the present invention.

### DETAILED DESCRIPTION OF THE PREFERRED EMBODIMENTS

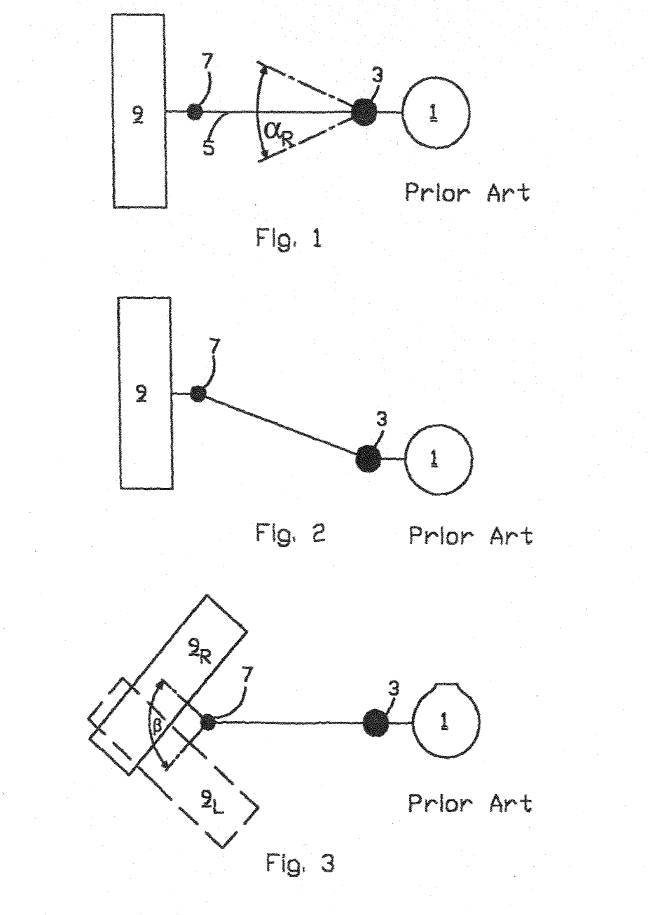

FIG. 1 shows a simplified schematic view of a known road car transmission to one driven left wheel, in a view taken along the car, looking forwardly from the rear. The transmission can be seen to comprise a differential 1, a halfshaft generally indicated 5, and a wheel 9. An inner joint 3 is provided in the halfshaft 5, commonly a CV joint. An outer CV joint 7 is also provided. As can be seen from FIG. 1, the total horizontal articulation angle αR for bump and rebound through which inner CV joint 3 must articulate is about 50 degrees for a typical road suspension (25 degrees above, and 25 degrees below horizontal). As the wheel 9 must remain substantially perpendicular to the road surface, outer CV joint 7 must also articulate through the same angle, but out of phase with the inner joint 3, as shown in FIG. 2, where the wheel 9 is at full bump travel.

Where the wheel 9 is also a steered wheel, the outer CV joint 7 has an additional function, as illustrated in FIG. 3. FIG. 3 is a simplified plan view from above of the transmission of FIGS. 1 and 2. As shown, the steered wheel 9 rotates through an angle from position 9R at full right steering lock to position 9L (shown in dotted line) at full left lock. Hence, the range of vertical rotation β may be up to 90 degrees. The horizontal angle of rotation αR and the vertical angle of rotation β account for the full range of movement of the outer CV joint 7 (from full bump and right hand steerlog lock, to full rebound and left hand steering lock).

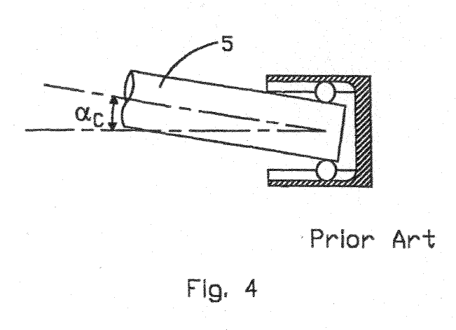

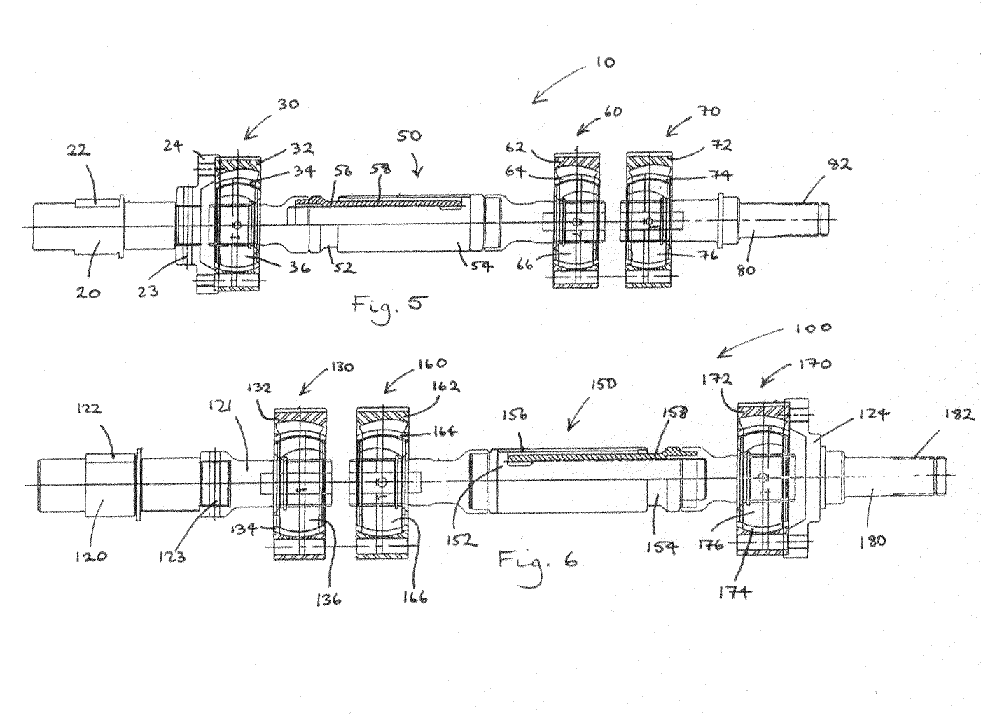

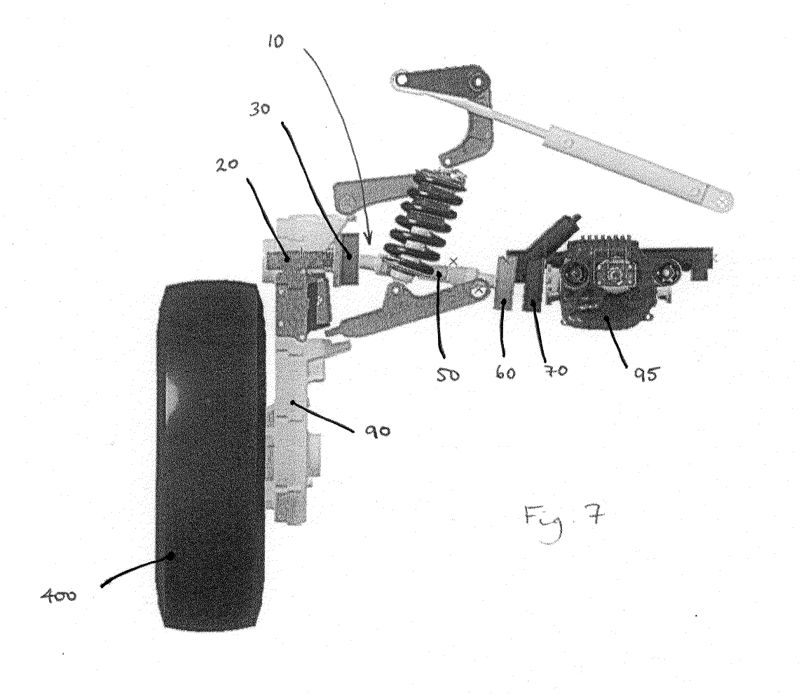

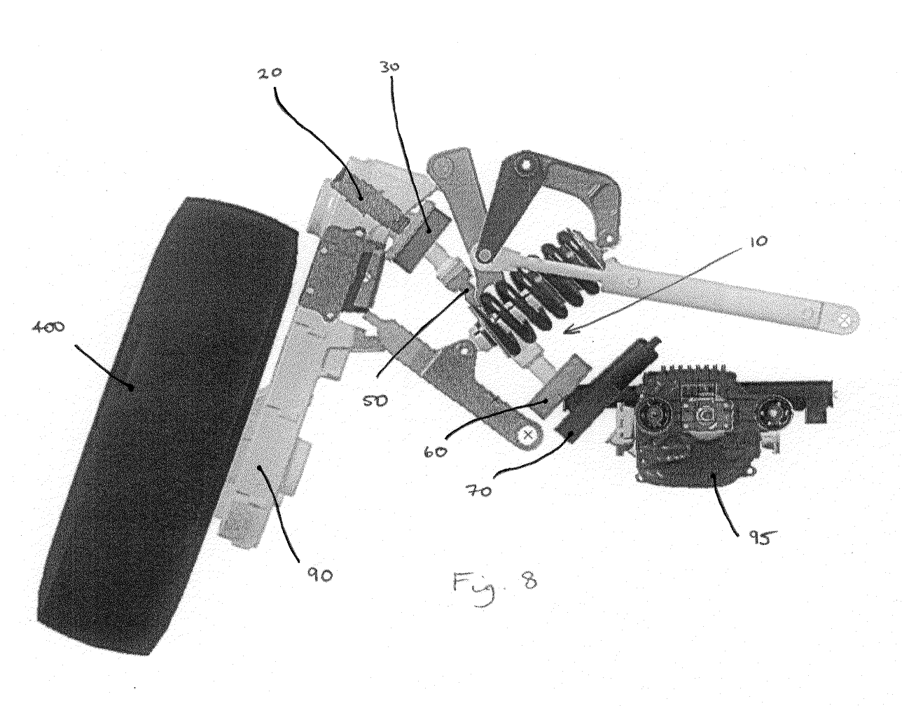

To maintain a consistent track dimension between the left and right wheels on a given axle, the effective length of the wheel driveshaft must be able to alter as the wheel travels up and down in bump and rebound. This is achieved on a typical road car (e.g. with front wheels which provide drive and steering) by using a plunge type joint as the inner CV joint 3, and a fixed joint as the outer CV joint 7. Whilst a plunge joint can provide for changes in the effective length of the driveshaft, a plunge joint can only operate within a more limited range of driveshaft angles, because the driveshaft will contact the outer sleeve when these angles are exceeded, as can be seen from the indicated angle αC in FIG. 4. A fixed joint can operate through a larger range of angles, and is therefore used as the outer joint 7 to accommodate steering as well as suspension travel. A further reason why the plunge joint is used as an inner joint 3 rather than as an outer joint 7 is because it is bulkier than a fixed joint, so it is more easily packaged adjacent to the differential rather than at the wheel hub, where it would otherwise compete for space with many other components. Furthermore, if fitted to the wheel hub, the heavier plunge joint would add unwanted unsprung weight.

In view of the foregoing, it will be appreciated that the need to retract wheel and track drives yet further, to wheel or track axle angles of 90 degrees or more above the horizontal, presents significant problems, not least in terms of the angle of articulation desired, packaging and weight.

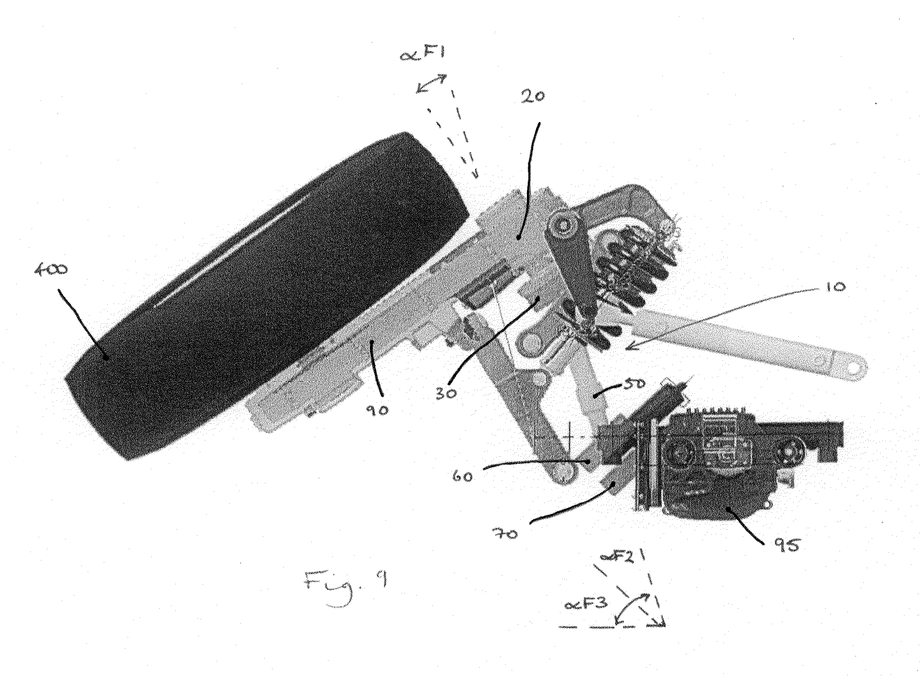

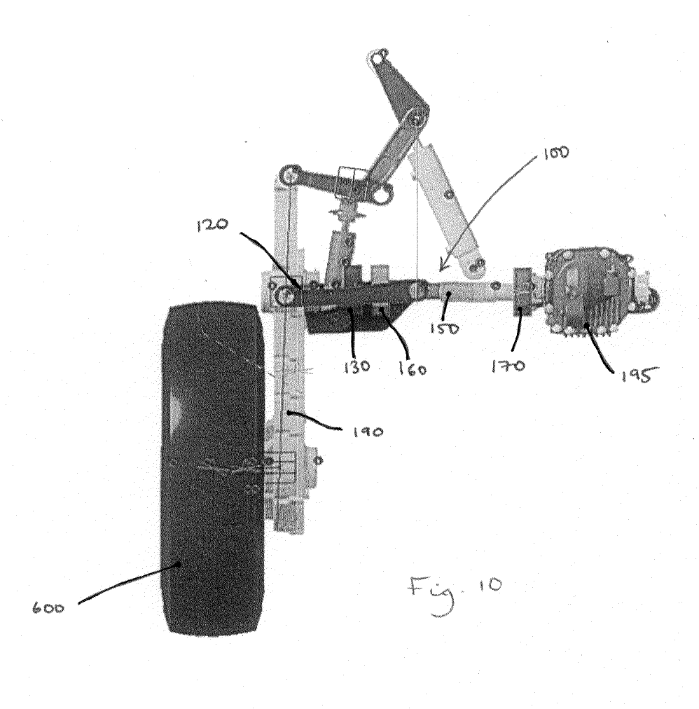

Referring next to FIGS. 5 and 7 to 9, there is shown a first preferred embodiment of halfshaft 10 according to the present invention. FIG. 5 is a schematic elevation view of the halfshaft 10. In the arrangement shown, the halfshaft 10 is for a front left hand steered wheel 400, and optionally driven. The front left hand suspension upright 90 (omitted in FIG. 5 for clarity) is mounted on a suspension upright stub shaft 20 of the halfshaft 10 at its left hand end. Drive is transferred from the halfshaft 10 (when driven) to the suspension upright 90 (which includes drop down drive to the wheel 400 by belt drive, gearing, etc.) via a key and keyway 22. At its right hand end, suspension upright stub shaft 20 is mechanically connected via a shaft pin 23 to a housing plate 24. In turn, the housing plate 24 is mechanically coupled, for example by way of a bolt or other mechanical fastening (omitted for clarity) to the outer raceway 32 of a first fixed CV joint 30. The first fixed CV joint 30 forms a first articulated connection with a mid shaft 50, the connection being formed by way of a ball spline connection formed between the CV outer raceway 32, CV ball bearings (omitted for clarity), CV cage 34 and CV core 36, and by way of the splined connection between the CV core 36 and the left hand end of the mid shaft 50. The mid shaft 50 in fact comprises two parts 52, 54 each provided with respective male and female splines 56, 58 for splined connection so as to accommodate changes in the length of the halfshaft 10 during use. The right hand end of the midshaft 50 is connected via splined connection to the CV core 66 of a second fixed CV joint 60. The second fixed CV joint 60 forms a second articulated connection with the midshaft 50, the connection being formed by way of a ball spline connection formed between the CV outer raceway 62, CV ball bearings (omitted for clarity), CV cage 64 and CV core 66, and by way of the splined connection between the CV core 66 and the midshaft 50. A third fixed CV joint 70 forms a third articulated connection with a differential stub shaft 80, the connection being formed by way of a ball spline connection formed between the CV outer raceway 72, CV ball bearings (omitted for clarity), CV cage 74 and CV core 76, and by way of a splined connection between the CV core 76 and the differential stub shaft 80. The respective CV outer raceways 62, 72 of the second and third fixed CV joints are mechanically coupled, for example by way of a bolt or other mechanical or other fastening method (omitted for clarity) so as to transmit torque. A centering mechanism (omitted from FIG. 5 for clarity, but shown in detail in section in FIG. 13 and described below) is preferably provided between the mid shaft 50 and stub shaft 80 to aid in controlling movement of the shafts in use. The right hand end of the differential stub shaft 80 is received in the differential 95 (omitted from FIG. 5 for clarity), from which drive is received (when driven) via splines 82. Each fixed CV joint 30, 60, 70, in use, is packed with grease and protected by way of a cover (“boot”) and suitable retaining clips (omitted for clarity).

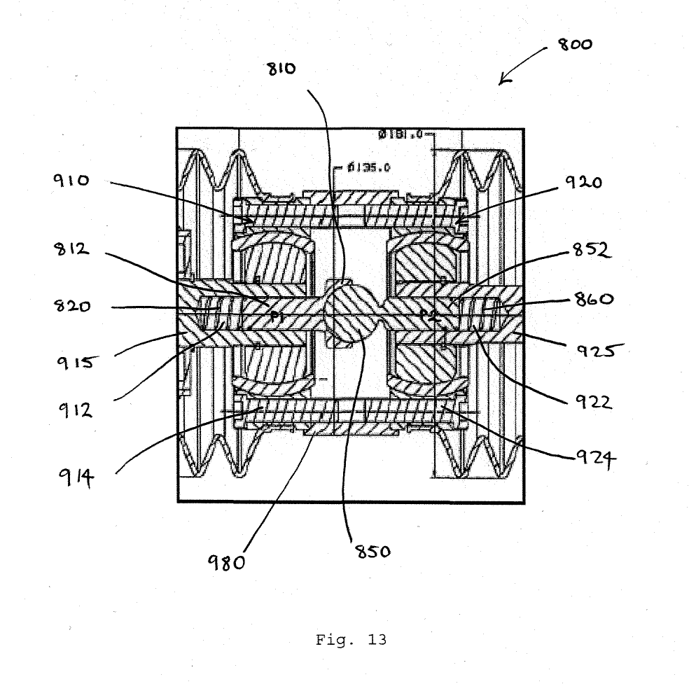

The halfshaft 10 is illustrated schematically in protracted, semi-retracted and fully retracted positions in FIGS. 7, 8 and 9 respectively. First, in FIG. 7, with front left steered (optionally driven) wheel 400 fully protracted, the first, second and third fixed CV joints 30, 60, 70 can be seen to have very shallow angles of articulation between each respective CV core 36, 66, 76 and CV outer raceway 32, 62, 72. Next, in FIG. 8, with the front left steered wheel 400 semi-retracted, the first and second fixed CV joints 30, 60 can be seen to have very shallow angles of articulation between each respective CV core 36, 66 and CV outer raceway 32, 62, whereas the third fixed CV joint 70 can be seen to have a more developed angle of articulation between its respective CV core 76 and CV outer raceway 72. Finally, in FIG. 9, with the front left steered wheel 400 fully retracted, the first CV joint 30 can be seen to have a more developed angle αF1 (˜20 degrees) of articulation between its respective CV core 36 and CV outer raceway 32, and the second and third fixed CV joints 60, 70 can be seen to have very significant angles of articulation αF2, αF3 between each respective CV core 66, 76 and CV outer raceway 62, 72 (˜73 degrees collectively).

Referring next to FIGS. 6 and 10 to 12, there is shown a further preferred embodiment of halfshaft 100 according to the present invention. FIG. 6 is a schematic elevation view of the halfshaft 100. In the arrangement shown, the halfshaft 100 is for a rear left hand wheel 600, and optionally driven. The rear left hand suspension upright 190 (omitted in FIG. 6 for clarity) is mounted on a suspension upright stub shaft 120 at its left hand end. Drive is transferred from the halfshaft 100 (when driven) to the suspension upright 190 (which includes drop down drive to the wheel 600 by belt drive, gearing, etc.) via a key and keyway 122. At its right hand end, suspension upright stub shaft 120 is mechanically connected via a shaft pin 123 to a stub shaft extension 121. A first fixed CV joint 130 forms a first articulated connection with the stub shaft extension 121, the connection being formed by way of a ball spline connection formed between the CV outer raceway 132, CV ball bearings (omitted for clarity), CV cage 134 and CV core 136, and by way of a splined connection between the CV core 136 and the right hand end of the stub shaft extension 121. A second fixed CV joint 160 forms a second articulated connection with a midshaft 150, the connection being formed by way of a ball spline connection formed between the CV outer raceway 162, CV ball bearings (omitted for clarity), CV cage 164 and CV core 166, and by way of a splined connection between the CV core 166 and the midshaft 150. The respective CV outer raceways 132, 162 of the first and second fixed CV joints 130, 160 are mechanically coupled, for example by way of a bolt or other mechanical or other fastening method (omitted for clarity) so as to transmit torque. A centering mechanism (omitted from FIG. 6 for clarity, but shown in detail in section in FIG. 13 and described below) is preferably provided between the mid shaft 150 and stub shaft extension 121 to aid in controlling movement of the shafts in use. The mid shaft 150 in fact comprises two parts 152, 154 each provided with respective male and female splines 156, 158 for splined connection so as to accommodate changes in the length of the halfshaft 100 during use. The right hand end of the midshaft 150 is connected via splined connection to the CV core 176 of a third fixed CV joint 170. The third fixed CV joint 170 forms a third articulated connection with the midshaft 150, the connection being formed by way of a ball spline connection formed between the CV outer raceway 172, CV ball bearings (omitted for clarity), CV cage 174 and CV core 176, and by way of the splined connection between the CV core 176 and the midshaft 150. In turn, a housing plate 124 is mechanically coupled, for example by way of a bolt or other mechanical fastening (omitted for clarity) to the outer raceway 172 of the third fixed CV joint 170. The housing plate 124 further comprises a differential stub shaft 180. The right hand end of the differential stub shaft 180 is received in the differential 195 (omitted from FIG. 6 for clarity), from which drive is received (when driven) via splines 182. Each fixed CV joint 130, 160, 170, in use, is packed with grease and protected by way of a cover 188 (“boot”) and suitable retaining clips (omitted in FIGS. 6, 10 and 11 for clarity).

The halfshaft 100 is illustrated schematically in protracted, semi-retracted and fully retracted positions in FIGS. 10, 11 and 12 respectively. First, in FIG. 10, with rear left (optionally driven) wheel 600 fully protracted, the first, second and third fixed CV joints 130, 160, 170 can be seen to have very shallow angles of articulation between each respective CV core 136, 166, 176 and CV outer raceway 132, 162, 172. Next, in FIG. 11, with the rear left wheel 600 semi-retracted, the first and second fixed CV joints 130, 160 can be seen to have very shallow angles of articulation between each respective CV core 136, 166 and CV outer raceway 132, 162, whereas the third fixed CV joint 170 can be seen to have a more developed angle of articulation between its respective CV core 176 and CV outer raceway 172. Finally, in FIG. 12, with the rear left wheel fully retracted, the first and second fixed CV joints 130, 160 can be seen to have very significant angles of articulation αR1, αR2 between each respective CV core 136, 166 and CV outer raceway 132, 162 (˜73 degrees collectively), and the third CV joint 170 can be seen to have a developed angle αR3 (˜12 degrees) of articulation between its respective CV core 176 and CV outer raceway 172.

FIG. 13 illustrates, schematically in cross-section, a centering mechanism 800 suitable for use between two adjacently arranged CV joints 910, 920 and respective shafts 915, 925. The CV joints 910, 920 can be the CV joints 60, 70 of FIG. 5, and the shafts 915, 925 can be the mid shaft 50 and stub shaft 80 of FIG. 5. Similarly, the CV joints 910, 920 can be the CV joints 130, 160 of FIG. 6, and the shafts 915, 925 can be the mid shaft 150 and stub shaft extension 121 of FIG. 6. The centering mechanism 800 can be seen to comprise an integral ball 850 and ball stub shaft 852, an integral socket 810 and socket stub shaft 812, and springs 820, 860. The spring 820 and socket stub shaft 812 are slidingly received in an aperture 912 provided in shaft 915, with the spring 820 acting to bias the socket stub shaft 812 against axial movement further into the aperture 912. Similarly, the spring 860 and ball stub shaft 852 are slidingly received in an aperture 922 provided in shaft 925, with the spring 860 acting to bias the ball stub shaft 852 against axial movement further into the aperture 922. The ball 850 and socket 810 are arranged in close proximity, with the ball 850 being received in the socket 810 and free to rotate therein. The respective dimensions of the integral ball 850 and ball stub shaft 852, integral socket 810 and socket stub shaft 812, and springs 820, 860 are such that the ball 850 is urged into contact with the socket 810 under the biasing action of the springs 820, 860 in all articulations of the CV joints 910, 920 and shafts 915, 925. In use, shaft 915 (acting as an input shaft) can transmit torque to shaft 925 (acting as an output shaft) via the respective external housings 914, 924 of the CV joints 910, 920 which are coupled together (e.g. via bolts (not shown) and/or a coupling/cover 980). The shaft 915 can pivot relative to the shaft 920 as provided for by the ball 850 and socket 810. Both the ball 850 and the socket 810 are connected to their respective (input/output) shafts 925, 915 by their sliding stub shafts 852, 812 which can slide axially (into and out of) as well as rotate relative to the (input/output) shafts 915, 925. The (input/output) shafts 915, 925 can move relative to the respective external housings 914, 924 by pivoting around the fixed pivot points P1, P2. When articulated about the fixed pivot points P1, P2, the adjacent ends of the (input/output) shafts 915, 925 must necessarily move away from each other. However, the ball 850 remains in contact with the socket 810 under the biasing action of the springs 860, 820, with the stub shafts 852, 812 sliding axially ‘out’ of the apertures 922, 912 of shafts 925, 915 in order to provide for the increased distance. The springs 860, 820 are preload springs and help overcome friction and permit the ball 850 to remain in the socket 810. Lubrication (and, optionally, packing with grease around the ball 850 and socket 810) may be provided as necessary. The centering mechanism 800 thus aids in controlling movement of the shafts 915, 925 in use. While a ball and socket arrangement has been described above, this is just one example. A universal joint with adequate angular capability could be beneficially employed in place of the ball and socket, as could any other mechanism which serves the same function.

It will thus be appreciated that the articulated halfshaft 10, 100 according to the present invention can provide for significant angles of articulation between input and output. Furthermore, it is also capable of providing steering, drive (transmitting power) and/or a constant speed of rotation between input and output at these significant angles of articulation, yet does so without suffering from the known geometrical problems (mechanical resistance and lockup) of prior art halfshafts.

Retractable wheel and suspension assemblies (selected parts are omitted from the attached Figures for clarity) as described in the applicant's patents and patent applications are particularly suitable for use with the articulated halfshaft 10, 100 of the present invention.

Whilst not shown, it is possible also to provide decouplers separately or integrated in the transmission illustrated. The provision of decouplers allows drive to the wheels or track drives to be disengaged when the amphibian is operated on water. As decouplers should be mounted rigidly to encourage smoothness of operation, it is preferred that decouplers be used on the inner CV joints. The CV joints may also include a synchromesh unit for smooth engagement and disengagement of said decouplers.

Whilst wheels 400, 600 have predominantly been referred to throughout for use as the land engaging and/or land propulsion means of the amphibian when operated on land, track drives or individual track drives (i.e. to replace a single wheel) may be used as an alternative or in combination with wheels.

Furthermore, it will be appreciated that drive (power) may be provided by internal combustion engines, electric motors, hydraulic motors, or hybrid engines in any suitable location (e.g. hydraulic wheel hub motors).

Although different embodiments of articulated halfshaft 10, 100 according to the present invention have been described above, any one or more or all of the features described (and/or claimed in the appended claims) may be provided in isolation or in various combinations in any of the embodiments. As such, any one or more these features may be removed, substituted and/or added to any of the feature combinations described and/or claimed. For the avoidance of doubt, any of the features of any embodiment may be combined with any other feature from any of the embodiments.

Accordingly, whilst preferred embodiments of the present invention have been described above and illustrated in the drawings, these are by way of example only and non-limiting. It will be appreciated by those skilled in the art that many alternatives are possible within the ambit, spirit and scope of the invention, as set out in the appended claims.

1. An articulated shaft for an amphibian driveline, the articulated shaft comprising:
at least two shaft portions; and
at least three points of articulation, wherein:
the articulated shaft is movable between a protracted position for use of the amphibian on land and a retracted position for use of the amphibian on water.

2. The articulated shaft as claimed in claim 1 wherein the at least two shaft portions comprise at least three shaft portions.

3. The articulated shaft as claimed in claim 2 wherein the at least three shaft portions comprise:
an inner shaft portion;
a mid shaft portion; and
an outer shaft portion.

4. The articulated shaft as claimed in claim 3 wherein the inner shaft portion includes a differential stub shaft which connects with a differential of the amphibian.

5. The articulated shaft as claimed in claim 3 wherein the mid shaft portion includes a mid shaft of variable effective length in use.

6. The articulated shaft as claimed in claim 3 wherein the mid shaft portion comprises two parts provided with mating splines slideably received one within the other to vary the effective length of the mid shaft portion in use.

7. The articulated shaft as claimed in claim 3 wherein the outer shaft portion is a suspension upright stub shaft which connects with a suspension upright of the amphibian.

8. The articulated shaft as claimed in claim 1 wherein the at least three points of articulation each comprise a constant velocity joint.

9. The articulated shaft as claimed in claim 1 wherein at least one of the at least three points of articulation comprises a constant velocity joint.

10. The articulated shaft as claimed in claim 1 wherein at least two of the at least three points of articulation each comprise a constant velocity joint.

11. The articulated shaft as claimed in claim 1 wherein at least three of the at least three points of articulation each comprise a constant velocity joint.

12. The articulated shaft as claimed in claim 1 wherein a total angle of articulation of the shaft achievable between its protracted position for use of the amphibian on land and its retracted position for use of the amphibian on water is at least 45 degrees.

13. The articulated shaft as claimed in claim 12 wherein the total angle of articulation of the shaft achievable between its protracted position for use of the amphibian on land and its retracted position for use of the amphibian on water is at least 65 degrees.

14. The articulated shaft as claimed in claim 13 wherein the total angle of articulation of the shaft achievable between its protracted position for use of the amphibian on land and its retracted position for use of the amphibian on water is at least 85 degrees.

15. The articulated shaft as claimed in claim 1 wherein the shaft is a halfshaft.

16. The articulated shaft as claimed in claim 1 wherein the shaft is a driven shaft.

17. The articulated shaft as claimed in claim 1 wherein the shaft is a non-driven shaft.

18. The articulated shaft as claimed in claim 1 further comprising:
a centering mechanism provided between two adjacent points of articulation.

19. The articulated shaft as claimed in claim 1 further comprising:
a centering mechanism provided between two adjacent shaft portions.

20. The articulated shaft as claimed in claim 18 or claim 19 wherein the centering mechanism comprises a ball and socket arrangement.

21. The articulated shaft as claimed in claim 18 or claim 19 wherein the centering mechanism comprises a universal joint type arrangement.

22. The articulated shaft as claimed in claim 18 further comprising:
at least one biasing means.

23. An amphibian comprising the articulated shaft as claimed in claim 1.

24. The amphibian as claimed in claim 23 wherein the amphibian comprises a powertrain and the shaft forms part of the powertrain of the amphibian.

25. The amphibian as claimed in claim 23 wherein the amphibian comprises:
at least one prime mover; and
at least one of at least one retractable wheel and at least one track drive, wherein the shaft transmits drive from the at least one primer mover to the at least one of the at least one retractable wheel and the at least one track drive.

26. The amphibian as claimed in claim 24 wherein the powertrain of the amphibian comprises at least one differential.

27. The amphibian as claimed in claim 24 wherein the powertrain of the amphibian comprises at least one decoupler.

28. The amphibian as claimed in claim 24 wherein the powertrain of the amphibian comprises at least one synchromesh.

29. The amphibian as claimed in claim 23 further comprising:
a retractable suspension assembly.

30. The amphibian as claimed in claim 23 operable in land and marine modes wherein when the amphibian is operated in the marine mode, sufficient hydrodynamic lift is achieved for the amphibian to plane.

31. The amphibian as claimed in claim 23 operable in land and marine modes wherein when the amphibian is operated in the land mode it can be driven in at least one of one of one, two, three and four wheel or track drive.

32. A powertrain comprising the articulated shaft as claimed in claim 1.
